(19) United States
(12) Patent Application Publication
(10) Pub. No.: US 2021/0083998 A1
(43) Pub. Date: Mar. 18, 2021

(54) Machine Logic Rules to Enhance Email Distribution

(71) Applicant: International Business Machines Corporation, Armonk, NY (US)

(72) Inventors: Paul R. Bastide, Ashland, MA (US); Robert E. Loredo, North Miami Beach, FL (US); Matthew E. Broomhall, Goffstown, NH (US)

(21) Appl. No.: 16/568,709

(22) Filed: Sep. 12, 2019

(51) Int. Cl. H04L 12/58; G06Q 10/10

(52) U.S. Cl. CPC H04L 51/14; G06Q 10/107

(57) ABSTRACT

Machine logic rules for adding, or recommending to add, recipients for an e-message based at least in part upon historical data relating to e-message distribution and content; machine logic rules for add adding, or recommending to add, text to an e-message based at least in part upon historical data relating to e-message distribution and content; and/or machine logic rules for responding to (for example, replying, forwarding), or recommending to respond to, an e-message based at least in part upon historical data relating to e-message distribution and content. Historical data relating to e-message distribution and content may be structured in the form of graphs with nodes and connections among and between the nodes.

### BACKGROUND

The present invention relates generally to the field of “electronic messages” (sometimes herein referred to as “e-messages”), and more particularly to helping to determine a recipient list for an e-message.

An “e-message” is any sort of text-based message of a type that is typically created and consumed on computer devices and is distributed over a communication network, such as the Internet. Types of e-messages include email and instant messaging chat messages. While generally including text, e-messages may additionally include other forms of data, such as images, video, audio and/or links to other computer-based content. E-messages are typically distributed by senders (also sometimes herein referred to as “original senders”), replying parties and/or forwarding parties, who manually send and/or re-send the e-messages. Some e-messages are sent automatically, such as automatic replies sent back when an e-message recipient is unavailable.

### SUMMARY

According to an aspect of the present invention, there is a method, computer program product and/or system that performs the following operations (not necessarily in the following order): (i) receiving a message-distribution-relevant data set including information potentially relevant to the desired content, desired recipients, and/or desired reply/forward chain for e-message communications; (ii) receiving a draft e-message data set corresponding to a first e-message that has not yet been sent from a sender to a set of original recipient(s); (iii) applying a set of machine logic-based rule(s) to the message-distribution-relevant data set and the draft e-message data set to determine a first potential change to an original recipient list of the first e-message; and (iv) responsive to the determination of the first potential change to the original recipient list, taking a responsive action.

According to a further aspect of the present invention, there is a method, computer program product and/or system that performs the following operations (not necessarily in the following order): (i) receiving a message-distribution-relevant data set including information potentially relevant to the desired content, desired recipients, and/or desired reply/forward chain for e-message communications; (ii) receiving a draft e-message data set corresponding to a first e-message that has not yet been sent from a sender to a set of original recipient(s); (iii) applying a set of machine logic-based rule(s) to the message-distribution-relevant data set and the draft e-message data set to determine a first potential change to content of a body of the first e-message; and (iv) responsive to the determination of the first potential change to the content of the body of the first e-message, taking a responsive action.

According to a further aspect of the present invention, there is a method, computer program product and/or system that performs the following operations (not necessarily in the following order): (i) receiving a message-distribution-relevant data set including information potentially relevant to the desired content, desired recipients, and/or desired reply/forward chain for e-message communications; (ii) receiving an e-message data set corresponding to a first e-message that has been sent from a sender to a set of original recipient(s); (iii) applying a set of machine logic-based rule(s) to the message-distribution-relevant data set and the draft e-message data set to determine a first potential reply/forward of first e-message from a first original recipient of the set of original recipient(s); and (iv) responsive to the determination of the first potential reply/forward of the first e-message, taking a responsive action.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIGS. 4A-4D are screenshot views generated by the first embodiment system;

FIG. 5 is a block diagram helpful in understanding the present invention;

FIG. 6 is a screenshot of an e-message to which the present invention may be applied;

FIG. 7 is a screenshot of a graph with nodes and edges according to an embodiment of the present invention;

FIG. 8 is a screenshot of the graph with nodes and edges according to an embodiment of the present invention; and

FIG. 9 is a table helpful in understanding the present invention.

### DETAILED DESCRIPTION

Some embodiments of the present invention are directed to machine logic rules for add adding, or recommending to add, recipients for an e-message based at least in part upon historical data relating to e-message distribution and content. Some embodiments of the present invention are directed to machine logic rules for add adding, or recommending to add, text to an e-message based at least in part upon historical data relating to e-message distribution and content. Some embodiments of the present invention are directed to machine logic rules for responding to (for example, replying, forwarding), or recommending to respond to, an e-message based at least in part upon historical data relating to e-message distribution and content. Historical data relating to e-message distribution and content may be structured in the form of graphs with nodes and connections among and between the nodes. This Detailed Description section is divided into the following subsections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be any thing made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

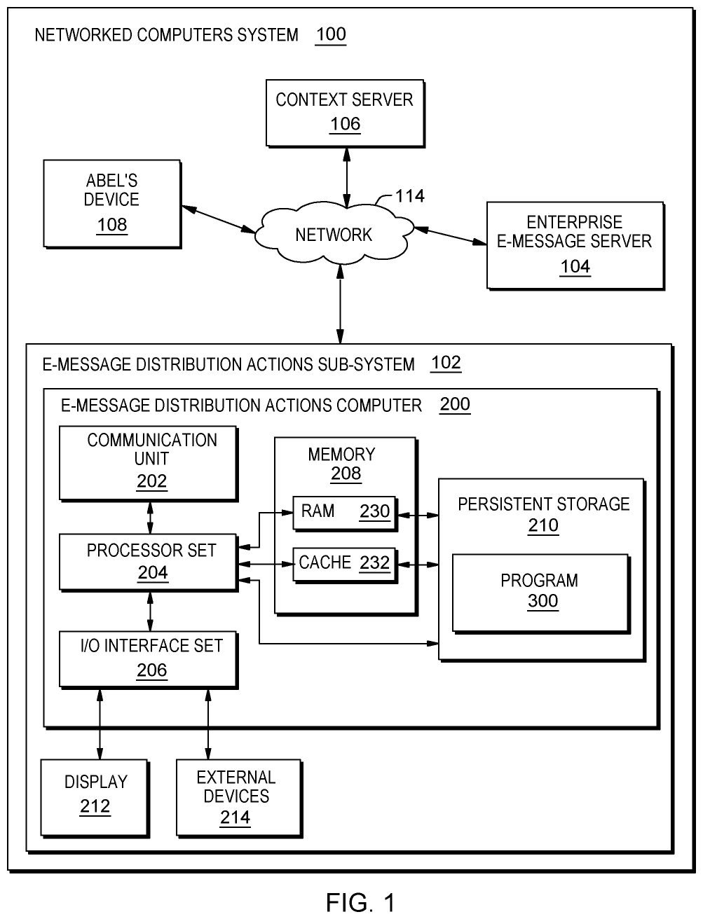

As shown in FIG. 1, networked computers system 100 is an embodiment of a hardware and software environment for use with various embodiments of the present invention. Networked computers system 100 includes: e-message distribution actions subsystem 102 (sometimes herein referred to, more simply, as subsystem 102); enterprise e-message server 104; context server 106; Abel's device 108; and communication network 114. Subsystem 102 includes: e-message distribution actions computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine-readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

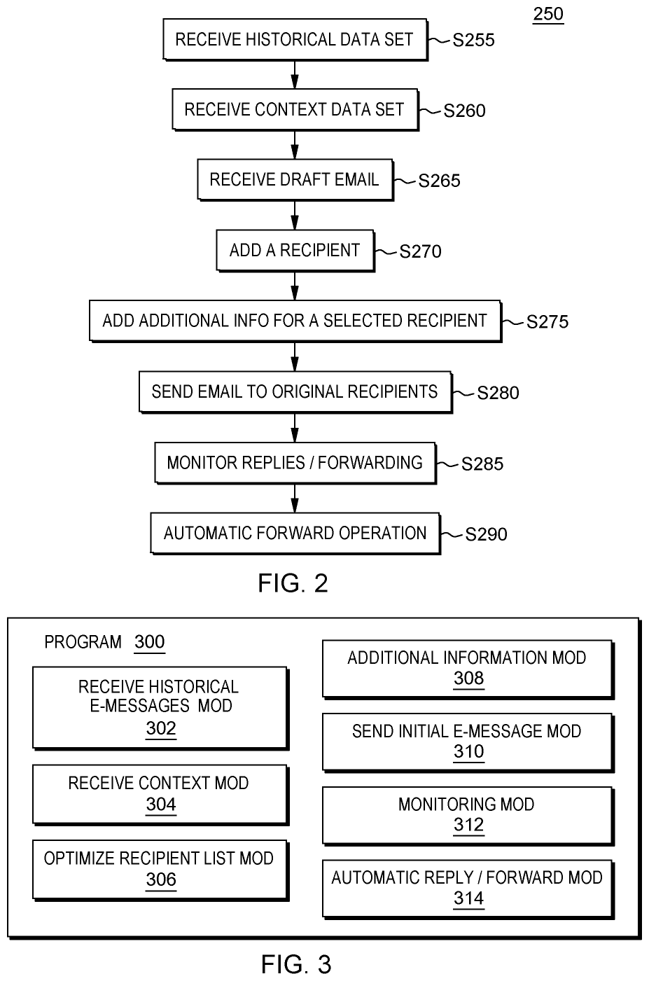

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation 5255, where receive historical e-messages module (“mod”) 302 receives a historical data set including information about e-messages that have been sent among and between people in an enterprise. In this embodiment, the historical data set: (i) comes from enterprise e-message server 104 over communication network 114; (ii) is intermittently and dynamically updated on an on-going basis; and (iii) includes: (a) e-message identification numbers, (b) text of the subject lines of the e-messages, (c) text of the message bodies of the e-messages, (d) links to attachments attached to the e-messages, (e) original, direct recipients of the e-messages, and (f) further includes forwarding and reply chains of the e-messages.

Processing proceeds to operation S260, where receive context mod 304 receives a context data set including information about people in operations of the enterprise. In this embodiment, the context data set: (i) comes from context server 106 over communication network 114 and is intermittently; (ii) is dynamically updated on an on-going basis; and (iii) includes: (a) for each employee of the enterprise, a list of projects to which the employee is assigned, (b) a list of employees of the enterprise who have current security clearances, and (c) return-to-work dates for employees that are on leaves of absence. Many other types of information can be included in the context data. For example, in an embodiment discussed in the following subsection of this Detailed Description section, an organizational chart for the company is provided as context data.

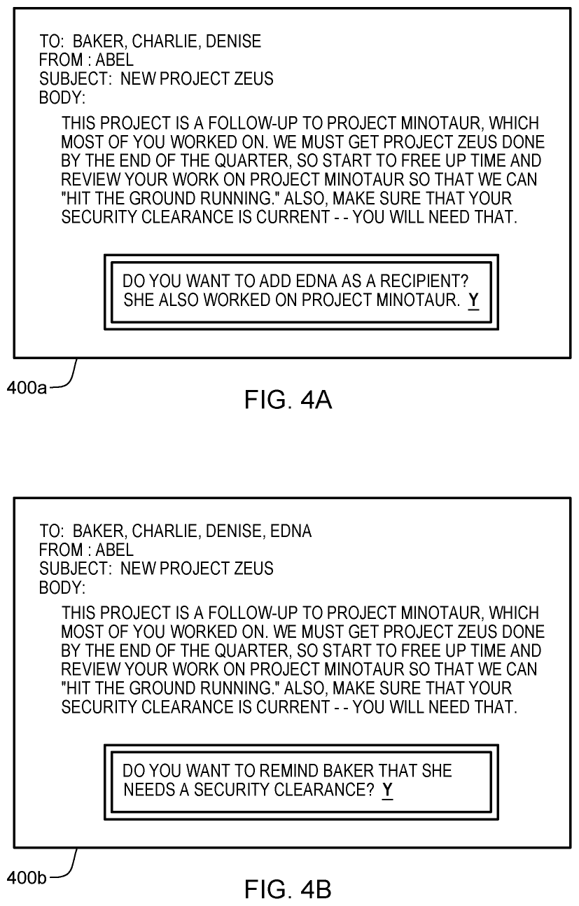

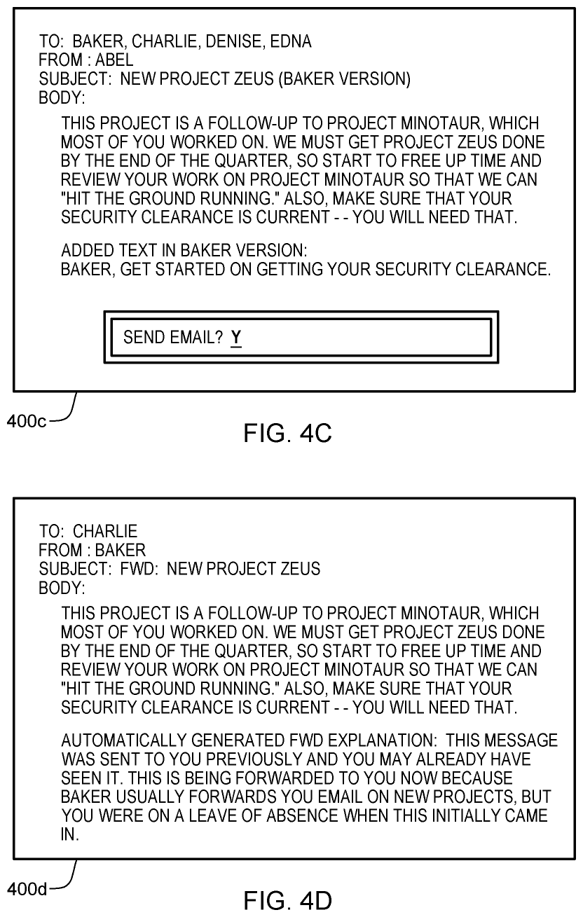

Processing proceeds to operation S265, where one of the employees of the enterprise, specifically an individual named Abel, begins to draft an email type e-message to original recipients Baker, Charlie and Denise (other employees of the enterprise), as shown in screenshot 400a of FIG. 4A. This draft email, which is not yet been sent to the recipients, is sent from Abel's device 108, through communication network 114 to program 300 for further processing, as will be discussed in the subsequent operations of flowchart 250.

Processing proceeds to operation S270, where optimize recipient list mod 306 applies machine logic rules to determine whether to suggest any changes to the recipient list in the draft email received at operation S265. In this example, natural language parsing determines that the email appears to be intended to be sent to all employees of the enterprise that have worked on Project Minotaur. Mod 306 consults the context data set of receive context mod 304 to determine that employee Edna has worked on Project Minotaur. Accordingly, and as shown in screenshot 400a, optimize recipient list mod 306 sends a suggestion to Abel's device 108 to the effect that perhaps Edna should be added to the recipient list of this email. As shown in screenshot 400a and screenshot 400b (of FIG. 4B), Abel agrees to the addition of Edna to the recipient list, and Edna is duly added to the recipient list for this draft email, which has not yet been sent.

Processing proceeds to operation S275, where additional information mod 308 determines whether additional information should be added for some, or all, recipients of the email. As will be discussed in the next subsection of this Detailed Description section, sometimes this additional information will be helpful to the recipient because it will explain to the recipient the reasons that they are receiving a particular e-message communication. Alternatively, or additionally, some embodiments may include machine logic-based rules for suggesting that certain information be removed from the email for some, or all, of the recipients. In this example, natural language parsing determines that the email appears to want to ensure that all recipients have, or quickly obtain, security clearances. Mod 308 consults the context data set of receive context mod 304 to determine that employee Baker does not have a current security clearance. Accordingly, and as shown in screenshot 400b, additional information mod 308 sends a suggestion to Abel's device 108 to the effect that perhaps the version of the email that Baker receives should have additional text reminding Baker that she needs to renew her security clearance. As shown in screenshot 400b and screenshot 400c (of FIG. 4C), Abel agrees to the additional reminder for Baker, and this reminder is duly added to the version of the draft email that is intended to be sent to recipient Baker. While this embodiment creates a second version of the email just for recipient Baker, because the additional information is Baker-specific, other embodiments could add the Baker-specific information to the main draft of the email so that all recipients see the additional information.

Processing proceeds to operation S280, where send initial e-message mod 310 sends out the various versions of the draft email to the various recipients pursuant to instruction from original sender Abel (see the bottom of screenshot 400 C). More specifically, the versions of the email are sent through communication network 114 to enterprise e-message server 104 so that the various recipients can retrieve the email when they use their respective devices to read their emails. In this example, most recipients will get a first version of the email without the Baker-specific added text, but Baker will get a second version of the email that includes the Baker specific added text.

Processing proceeds to operation S285, where monitoring mod 312 monitors the forwarding and replying activities with respect to the email sent by Abel at operation S280. In this example, monitoring mod 312 determines that Baker has not forwarded the email to Charlie.

Processing proceeds to operation S290, where automatic reply/forward mod 314 consults the historical data set of receive historical e-messages mod 302 to determine that Baker usually does forward e-messages concerning new projects to Charlie, even in cases where Charlie is on the original recipient list for the new-project-related email. Because of this, and further because operation S285 has determined that Baker has not yet forwarded the message to Charlie, mod 314 determines that it will automatically forward the email from Baker's account, on Baker's behalf, to Charlie. Furthermore, mod 314 determines the timing for this forwarding based on leave of absence data for Charlie that is present in the context data set of receive context mod 304. When forwarding the email to Charlie, mod 314 adds explanatory text regarding the decision to forward, as shown in screenshot 400d of FIG. 4D. In this way, Charlie will know that this email forward was automatically generated, and will have some idea why this email forward was automatically generated. Alternatively, in some embodiments mod 314 may simply suggest to Baker that the email be forwarded to Charlie at the time Charlie's leave of absence is over.

It is noted that operation S290 consults both the historical emails of the historical data set and the context data of the context data set when taking action with respect to the e-message distribution actions. On the other hand, operations S270 and S275 only used the context data set and did not consult previous emails of the historical data set. In various embodiments of the present invention, the machine rules to change (or suggest to change) the recipient list, the machine rules to change (or suggest to change) the text included in email, and/or the machine rules to automatically reply/forward (or suggest a reply or a forward) may consult either, or both, of historical data and/or context data. In this document, data that includes either, or both, of historical data and/or context data shall be referred to a “message-distribution-relevant data” or a “message-distribution-relevant data set.”

### III. FURTHER COMMENTS AND/OR EMBODIMENTS

Some embodiments of the present invention recognize the following facts, potential problems and/or potential areas for improvement with respect to the current state of the art: (i) with the wealth of messages, there are many messages which are missed; (ii) the best case is the message goes viral the viral message is quickly picked up, acted on, commented on and gains popularity; (iii) these messages often die as quick as the messages go viral; (iv) one problem is the ability to address messages to every single person, for example: (a) when broadcasting a training opportunity the user may think “why was this sent to me?,” (b) when broadcasting earnings results, the user may think “what did I contribute?”, and (c) when a message is labeled must act, confirm and or act on, the user may think “why me?”; and/or (v) there is a clear need to optimize the message delivery, so the user fully groks the context and acts on the message.

Some embodiments of the present invention may include one, or more, of the following operations, features, characteristics and/or advantages: (i) message addressee selection optimization; and/or (ii) incorporates mails and stitches them into a propagation strategy that maximizes utility.

A method according to an embodiment of the present invention includes the following operations: (i) identifying the intended audience of the message; (ii) generating a social and collaboration flow graph for the intended audience, the sender and topic; (iii) modeling the flow from sender to the audience; (iv) establishing, based on the model, monitors related to the flow to the intended audience; (v) building, based on the state of the monitors, a secondary model from the current edge to the intended audience; and (vi) acting on the secondary model to present actions to the edge recipients.

It is better to engage people like that in a dialogue, rather than punching them in the face. (i) automatically sends messages from the edge ‘on-behalf’ or based on a hierarchical importance ‘forward’; (ii) includes double delivery simulations; (iii) links or includes previously discussed topics in the conversation to sections of the content that relates to both sender and recipient and highlight these as reasons for inclusion/exclusion from the initial list; and/or (iv) the secondary model may use these to highlight reasons the user should pay attention. For example, a message comes in about patenting. There is a section in the message which touches on a subject Fred and Barney discussed. Some embodiments of invention includes that relationship between the current message and previous message(s) that relate to the common subject. For example, this relationship could be indicated by repeating the previous message(s) in the body of the current message with pertinent portions of the text highlighted, bolded and more italicized.

A method according to an embodiment of the present invention includes the following operations: (i) reconciles granularity at a default message level; (ii) capable of paragraph or sentence level subject/topic concept detection; (iii) ability to chain together conversations based on conversation-ids and use the chain as part of the graph; (iv) enables granular selection, boiling away extraneous text and drawings, to focus on the part that is interesting as the message gets to the edge (for example, user ‘Matt’ forwards and highlights the relevant parts of a message for the downstream recipients); and (v) some potential advantages the are: (a) increase the delivery and action for important messages, and (b) license to social network vendors and services.

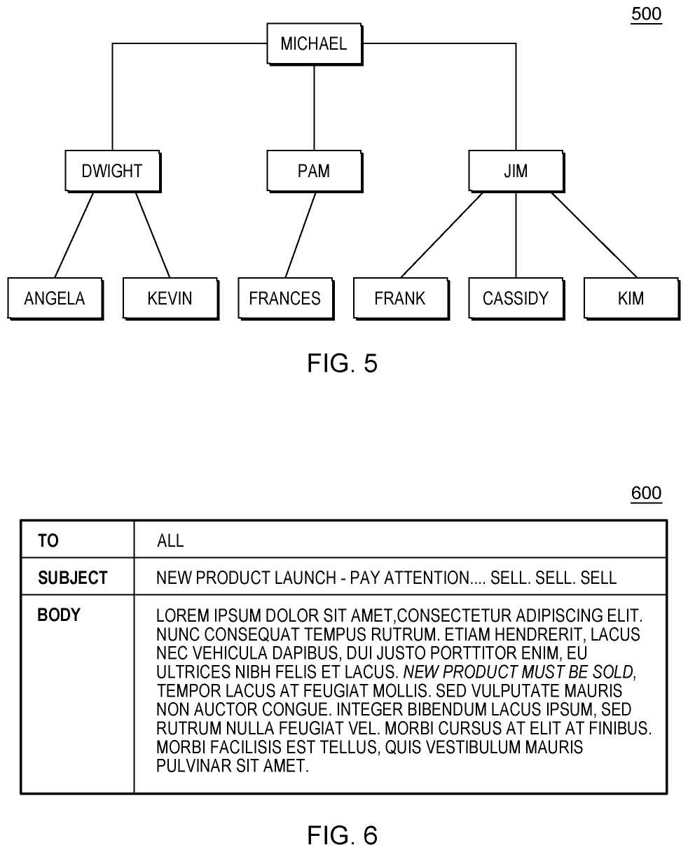

An example of the present invention will now be discussed with reference to: (i) organizational hierarchy diagram 500 of FIG. 5; and (ii) email screenshot 600 of FIG. 6; and (iii) topic concept flow diagram 700 (showing collaboration). In this example, Michael is the head of sales for a large corporation. His abbreviated organization chart is as shown in diagram 500 of FIG. 5. Michael needs his team to act quickly with respect to a new product launch. Michael starts drafting a new email as shown in screenshot 600 of FIG. 6. This example, the email identifies that: (i) it relates to a “new product”; and (ii) it further relates to “sales.” This suggests that the email should be sent to a sales engineer, people who work in a sales department, a product offering team for the “new product.”

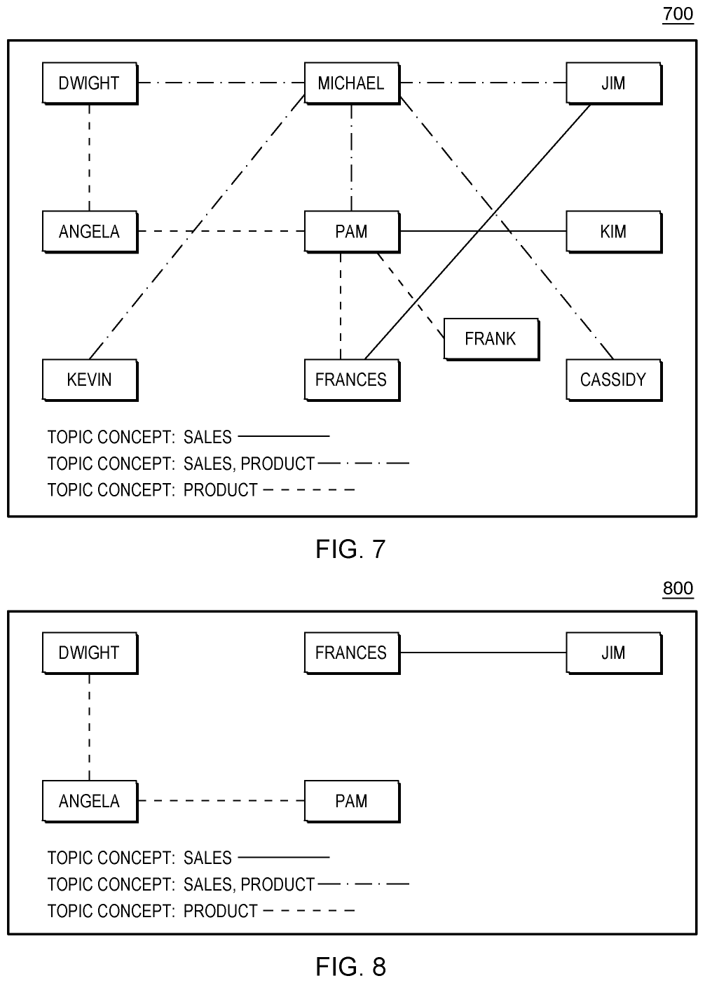

The invention generates the flow graph for the intended audience, the sender and topic as shown in the topic concept flow—collaboration and conversation and message graph (diagram 700) of FIG. 7. The invention considers the sent and read time to determine the speed of dissemination. The invention models the optimal flow from sender to the audience, and generates the following walks based on the sales topic: (i) Michael to Pam, Dwight, Kevin, Cassidy, Jim; (ii) Dwight, Pam to Angela; (iii) Pam to Kim, Frank, Frances; and (iv) Jim to Frances.

This example alters the ‘To’ and adds Pam, Dwight, Kevin, Cassidy, Jim. The invention also adds a statement “Please disseminate to relevant parties interested in the topic.” This step is generally considered optional, however in this scenario, it exemplifies the value of the invention. In one embodiment, the invention establishes, based on the model, monitors related to the flow to the intended audience. In another embodiment, the invention selects the secondary senders and establishes a monitor with the archiving and compliance feeds. The monitor inspects: (i) monitor-1: Dwight, Pam to Angela—message—has subject—sales? with extra paragraphs; (ii) monitor-2: Pam to Kim, Frank, Frances—message—has subject—sales? with extra paragraphs; and (iii) monitor-3: Jim to Frances—message—has subject—sales? with extra paragraphs.

In one embodiment, the invention sets a timeout for the monitors of one day. Pam sends the original message to Kim and Frances and Frank, telling them of the value of the new product and the improve sales opportunities. The monitor is tripped. Dwight sends the original message to Angela, without any quotations or extra detail. The monitor is not tripped. The invention builds, based on the state of the monitors, a secondary model from the current edge to the intended audience.

In one embodiment of the present invention, secondary model diagram 800 is shown in FIG. 8. In another embodiment, the invention acts on the secondary model to present actions to the edge recipients. The invention automatically sends messages from the edge ‘on-behalf’ or based on a hierarchical importance ‘forward’, such as: (i) on behalf of Pam, don't forget the product message; and (ii) on behalf of Jim, don't forget the sales message. In another embodiment, the invention includes double deliveries, and have Dwight resent the message to Angela with extra required detail.

Some embodiments of the present invention may include one, or more, of the following operations, features, characteristics and/or advantages: (i) integrates with Collaboration, Instant Messaging and Social Media communication services—IBM Verse, Gmail, Slack, Sametime, SMS, Apple iMessage, Skype, Facebook, IBM Connections, WhatsApp, or one of the open source conversation solutions; (ii) archives messages into a datastore and identifies the messages based on conversation-id and time and the completion of the messages. The invention may use a tool like Gnip or Actiance to pull the Social data into the secondary storage for analysis; (iii) while methods to extract the data exist to poll Social APIs, such as the Twitter API, IBM Connections API, and scrape the user interface of these tools, there is a strong preference to the stream-based processing which ensures a logical ordering of messages based on time, and improves performance as the scaling is at the backend data processing tier, not the presentation and integration tier; and (iv) The data is loaded into an analytical data store/atomic table using the following rough schema: (a) message details {body, subject, metadata}, (b) topic concepts/category (0 . . .* -concept-1, concept-2, concept-3), (c) unique message identifier—generated or extracted from the message, (d) read time—time the message is read; (e) received time—time the message is received, (f) sent time—time the message is sent, (g) access control—membership list of the conversation, (h) owner—the owner/author of a specific message, if the user is unknown the message is marked as UNKOWN. For instance, when a user leaves a company, (i) location (GPS (global positioning system), longitude/latitude, region): (j) tenant—the assigned company or group, used for sharding the data and landing the data in a controlled data store, (k) terminal—indicating the message was the end of the conversation; and (l) weights: views, participation metrics.

Some embodiments of the present invention may include one, or more, of the following operations, features, characteristics and/or advantages: (i) adds other metadata to the table indicating the access control member's reputation, expertise area, author reputation, author expertise area or sentiment; and (ii) configure thresholds for inclusion in the analytics. For example, the user has discussed many customer issues related to Spring framework recently, thus showing a strong relationship to his core projects, versus the discussion on IBM Connections which shows a weak relationship and should not be included in the analysis.

Some embodiments of the present invention may include one, or more, of the following operations, features, characteristics and/or advantages: (i) populates the concepts and categories using Watson Natural Language Classifier; (ii) populates sentiment, severity and importance metadata. If the conversation identifier is not included in the metadata, the invention asserts a conversation based on participant lists (to, cc, bcc) or the invention hashes the natural language using stemmed and lemmatized into a normal form; (iii) uses custom labels from the MIME data such as tags or labels which are used to populate the Topic Category for email messages; (iv) considers unique MIME types as unique messages; (v) federates messages from different services—de-duplicating messages based on time-author-audience, joining streams of messages based on time-author. The federation of messages may be based on UTC, or Time Zone normalized messages. For instance, Fred works in Central Time and starts his day at 9:00 AM Eastern, 8 AM Central. The invention normalizes Fred's time zone to 9:00 AM; (vi) identifies the intended audience of the message; (vii) mines the previous messages sent by the users with relation to the distribution list and the topics, concepts and subject; (viii) assigns a probabilistic weight to the subject/topic concept in relation to the people who are intended to see the message; (ix) expands any starting distribution list—for example, global sales employees becomes Michael, Jim, Pam, etc.; (x) generates a social and collaboration flow graph for the intended audience, the sender and topic; and (xi) builds the conversation graph, ideally the data is loaded into Apache HBase with Spark and Spark GraphX. The graph is realized using the metadata loaded from the social network datastore as nodes and edges.

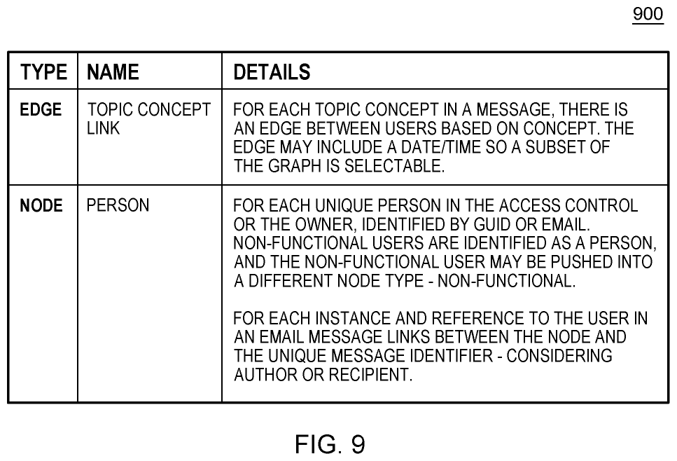

As shown in FIG. 9, table 900 includes Type, Name and Details.

Some embodiments of the present invention may include one, or more, of the following operations, features, characteristics and/or advantages: (i) modeling the flow from sender to the audience; (ii) models the flows through the graph for the specific topic, selecting only the topic and audience of immediate effect between the user and direct prior conversation topics; (iii) requires bi-directional communication before it is confirmed to be a flow; (iv) aggregate prior messages/topics into a weighted edge, which becomes a historic anchoring in the graph; (v) establishes, based on the model, monitors related to the flow to the intended audience; (vi) based on the modeled topics, selects the prior direct communications and second level communications to monitor; (vii) links into the compliance stream/feed and monitors the feed for an “If-this-then-remove-monitor”; (viii) establishes a timeout—for example: 24 hours, 3-days, 8 Hours; (ix) builds, based on the state of the monitors, a secondary model from the current edge to the intended audience; (x) removes the monitors; (xi) builds a secondary graph/model; (xii) uses remaining monitors as calls to action; (xiii) acts on the secondary model to present actions to the edge recipients ; (xiv) automatically sends messages from the edge ‘on-behalf’ or based on a hierarchical importance ‘forward’; (xv) includes double deliveries, and have Dwight resent the message to Angela with extra required detail; (xvi) includes required and blocking actions for users; and (xvii) requires injected paragraphs and annotations.

A method according to an embodiment of the present invention includes the following operations: (i) identifying an intended audience of a message; (ii) generating a social and collaboration flow graph for the intended audience, the sender and the topic; (iii) modeling the flow from the sender to the audience; (iv) establishing, based on the model, monitors related to the flow to the intended audience; (v) building, based on the state of the monitors, a secondary model from the current edge to the intended audience; and (vi) acting on the secondary model to present actions to the edge recipients.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

In an Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) comprising:
receiving a message-distribution-relevant data set for a planned e-message communication, with the message-distribution relevant data set including an identification of at least the following: an intended audience for the e-message, an identity of a sender and an identification of the topic of the planned e-message communication;
generating a social and collaboration flow graph for the intended audience, the sender and the topic;
building a first model that models a flow from sender to the intended audience;
establishing, based on the first model, monitors related to the flow to the intended audience;
building, based on the state of the monitors, a second model from a current edge to the intended audience; and
acting on the second model to present a set of action(s) to the sender.

2. The CIM of claim 1 wherein the set of action(s) includes a suggestion to make the first potential change to the original recipient list.

3. The CIM of claim 1 wherein the set of action(s) includes automatically making the first potential change to the original recipient list.

4. The CIM of claim 1 wherein:
the message-distribution-relevant data set further includes historical data relating to previous e-messages that have been composed, sent, replied to and/or forwarded; and
the generation of the social and collaboration flow graph is based, at least in part, on the historical data.

5. The CIM of claim 1 wherein the message-distribution-relevant data set further includes context data relating to potential senders, potential original recipients and/or potential forwarding recipients of e-messages.

6-18. (canceled)

19. A computer program product (CPP) comprising:
a set of storage device(s), with each storage device including a set of storage medium(s); and
computer code collectively stored on the set of storage devices, with the computer code including data and instructions for causing a set of processor(s) to perform the following operations:
receiving a message-distribution-relevant data set for a planned e-message communication, with the message-distribution relevant data set including an identification of at least the following: an intended audience for the e-message, an identity of a sender and an identification of the topic of the planned e-message communication,
generating a social and collaboration flow graph for the intended audience, the sender and the topic,
building a first model that models a flow from sender to the intended audience,
establishing, based on the first model, monitors related to the flow to the intended audience,
building, based on the state of the monitors, a second model from a current edge to the intended audience, and
acting on the second model to present a set of action(s) to the sender.

20. The CPP of claim 19 wherein the set of action(s) includes a suggestion to make the first potential change to the original recipient list.

21. The CPP of claim 19 wherein the set of action(s) includes automatically making the first potential change to the original recipient list.

22. The CPP of claim 19 wherein:
the message-distribution-relevant data set further includes historical data relating to previous e-messages that have been composed, sent, replied to and/or forwarded; and
the generation of the social and collaboration flow graph is based, at least in part, on the historical data.

23. The CPP of claim 19 wherein the message-distribution-relevant data set further includes context data relating to potential senders, potential original recipients and/or potential forwarding recipients of e-messages.

24. A computer system (CS) comprising:
a processor(s) set;
a set of storage device(s), with each storage device including a set of storage medium(s); and
computer code collectively stored on the set of storage devices, with the computer code including data and instructions for causing the processor(s) set to perform the following operations:
receiving a message-distribution-relevant data set for a planned e-message communication, with the message-distribution relevant data set including an identification of at least the following: an intended audience for the e-message, an identity of a sender and an identification of the topic of the planned e-message communication,
generating a social and collaboration flow graph for the intended audience, the sender and the topic,
building a first model that models a flow from sender to the intended audience,
establishing, based on the first model, monitors related to the flow to the intended audience,
building, based on the state of the monitors, a second model from a current edge to the intended audience, and
acting on the second model to present a set of action(s) to the sender.

25. The CS of claim 24 wherein the set of action(s) includes a suggestion to make the first potential change to the original recipient list.

26. The CS of claim 24 wherein the set of action(s) includes automatically making the first potential change to the original recipient list.

27. The CS of claim 24 wherein:
the message-distribution-relevant data set further includes historical data relating to previous e-messages that have been composed, sent, replied to and/or forwarded; and
the generation of the social and collaboration flow graph is based, at least in part, on the historical data.

28. The CS of claim 24 wherein the message-distribution-relevant data set further includes context data relating to potential senders, potential original recipients and/or potential forwarding recipients of e-messages.
